(19) United States
(12) Patent Application Publication
(10) Pub. No.: US 2015/0052790 A1
(43) Pub. Date: Feb. 26, 2015

(54) IDENTIFICATION SYSTEM FOR BEER FONTS, GROWLERS, AND WINE BOTTLES

(71) Applicant: JAMES MATT LOGUE, ARLINGTON, TX (US)

(72) Inventor: James Matthew Logue, Arlington, TX (US)

(21) Appl. No.: 13/972,931

(22) Filed: Aug. 22, 2013

(51) Int. Cl. B67D 1/08; B67D 3/00

(52) U.S. Cl. CPC B67D 1/0877; B67D 3/0096
USPC 40/332

(57) ABSTRACT

The present invention disclosure reveals an easily changed beer font and wine bottle or growler cork system that comprises easily changed standardized faceplates useful for quick identification. A font body is affixed to the industry standard beer tap or cork, a sliding mechanism allows for quick change of a identifying faceplate, and a magnet pair mounted on the faceplate and font body to assist the assembly's rigidity and security.

### TECHNICAL FIELD OF THE INVENTION

The present disclosure relates generally to beer fonts, growlers, and wine bottle corks, as they are used to identify and organize liquids in private or commercial settings.

### BACKGROUND OF THE INVENTION

In recent years, drinking establishments have found commercial success by offering ever larger selections of draft beers. To assist bartenders in sales efforts, beer makers and distributors sell elaborate identifying fonts, or handles, that mount on beer taps, often displaying a trademark logo on a faceplate mounted vertically on the fount, oriented toward would-be customers.

A ‘font’ is a handle that the serving bartender pulls forward to release beer into a glass. These vendor-provided fonts have gotten larger over time, as the beer distributors seek to receive more attention from restaurant clients. The most garish fonts can be more than a foot tall from the tap.

The industry's current practices requires a bartender to change out fonts by unscrewing them from a screw stud extending from a beer tap. Rotating and removing the font by unscrewing it from the screw stud on the tap can take more time than a busy bartender has to spare.

Bartenders also tend to have several different bottles of wine open at any given time, typically house wines or featured wines sold by the glass. Similarly, bartenders often keep beer growlers available when they don't have beer on tap. Both open wine bottles and beer growlers are kept in one location at the bar; a bartender must pick up each bottle in order to read the bottle label and identify the liquid to be served.

The restaurant and bar industry needs a system to quickly change beer tap fonts and quickly identify and organize opened wine bottles during restaurant operations.

### SUMMARY OF THE INVENTION

The present disclosure provides an easily changed beer font and wine cork system that comprises easily changed standardized faceplates useful for quick identification.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts and in which the drawings show several embodiments:

FIG. 1 is an orthogonal view of a first embodiment of the invention.

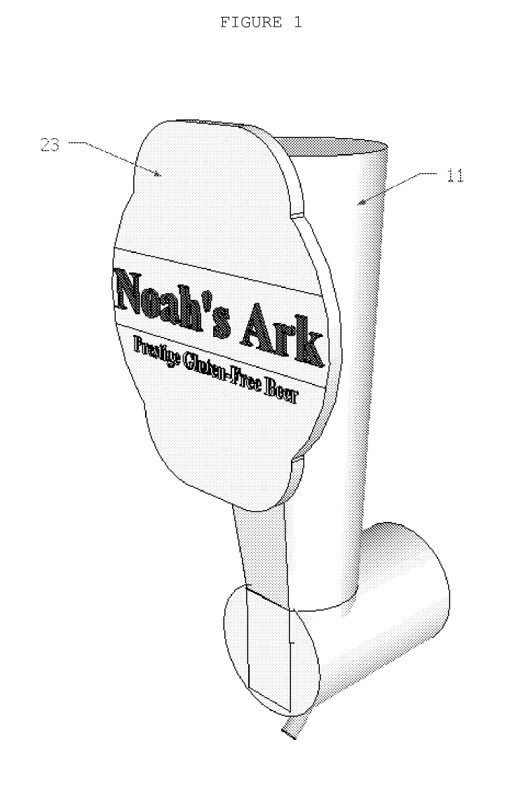

FIG. 2 is an exploded orthogonal view of a first embodiment of the invention.

FIG. 3 depicts an orthogonal view of a first embodiment of a font mount without a faceplate installed.

FIG. 4 shows an orthogonal view of the back of one embodiment of a faceplate.

FIG. 5 shows the top view of one embodiment of a faceplate.

FIG. 6 depicts a second embodiment of a font mount installed on a cork.

FIG. 7 is an orthogonal exploded view of a second embodiment of the invention as a cork-mounted beverage faceplate.

FIG. 8 is an orthogonal exploded view of a second embodiment of the invention as a cork-mounted beverage faceplate from a bottom perspective.

DRAWING LEGEND: The following legend is useful for examination of the drawings:

11—Tap-Mounted Interchangeable Faceplate Assembly

13—Tap Stud

15—Male Mounting Threads

16—Female Mounting Threads

17—Font Body

19—Font-Body Faceplate Female Slide

21—Faceplate-Mounted Male Slide

23—Faceplate

25—Faceplate Magnet

27—Font Body Magnet

31—Cork-Mounted Interchangeable Faceplate Assembly

53—Stud-Equipped Cork

### DETAILED DESCRIPTION OF THE INVENTION

While the making and using of various embodiments of the present disclosure is given while considering a particular embodiment, it should be appreciated that the present disclosure provides an inventive concept that can be embodied in a wide variety of specific contexts. The disclosure is primarily described and illustrated in conjunction with one embodiment of the presently-described systems and methods. The specific embodiments discussed herein are, however, merely illustrative of specific ways to make and use the disclosure and do not limit the scope of the disclosure.

The invention has two main embodiments, one for use on beer taps and similar beverage dispensers, and the second for use on beer growlers, wine bottles and other containers.

Though the drawings include only a single faceplate; the invention anticipates that a similarly sized faceplate will be designed for each beverage to be served, but shaped to reflect its trademarked appearance.

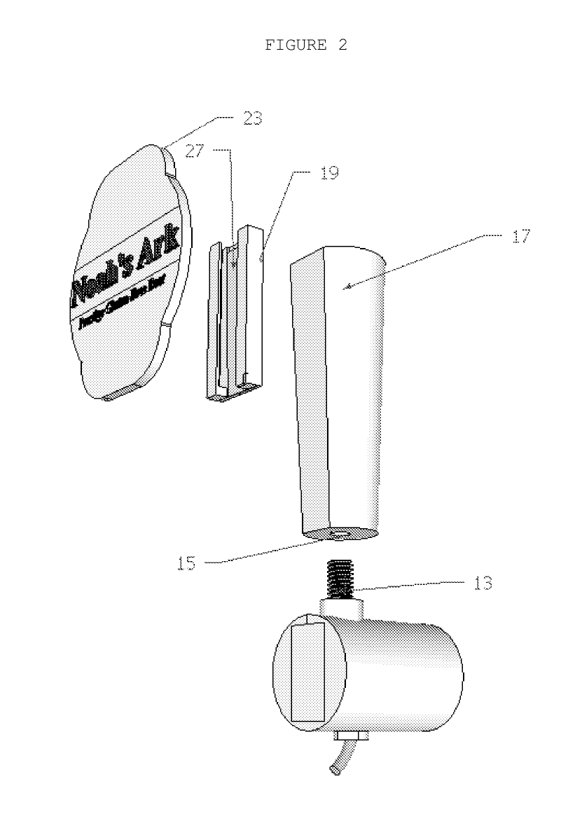

As seen in FIGS. 2, 7, and 8, the invention as currently designed continues to use the beer Tap Stud 13 with Male Mounting Threads 15 that is common in the hospitality industry.

FIG. 2 shows the optional Font Body Magnet 27, which pulls on an installed Faceplate 23 that has a corresponding Faceplate Magnet 25 of opposite polarity.

The first embodiment, for use on beer taps, is a Tap-Mounted Interchangeable Faceplate Assembly 11, comprising a Font Body 17 that connects to the industry-standard Tap Stud 13 by Female Threads 16 in the bottom of the Font Body 17, and a Faceplate 23 that connects to the Font Body 17.

In this first embodiment, the Faceplate 23 attachment is by means of a Female Slide affixed to the Font Body 17 and a matching Male Slide 21 affixed to the back of the Faceplate 23.

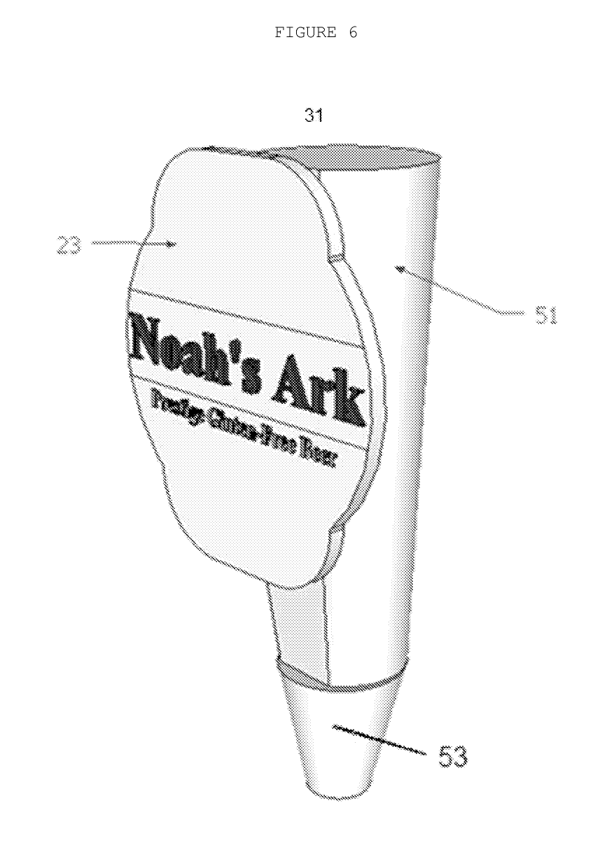

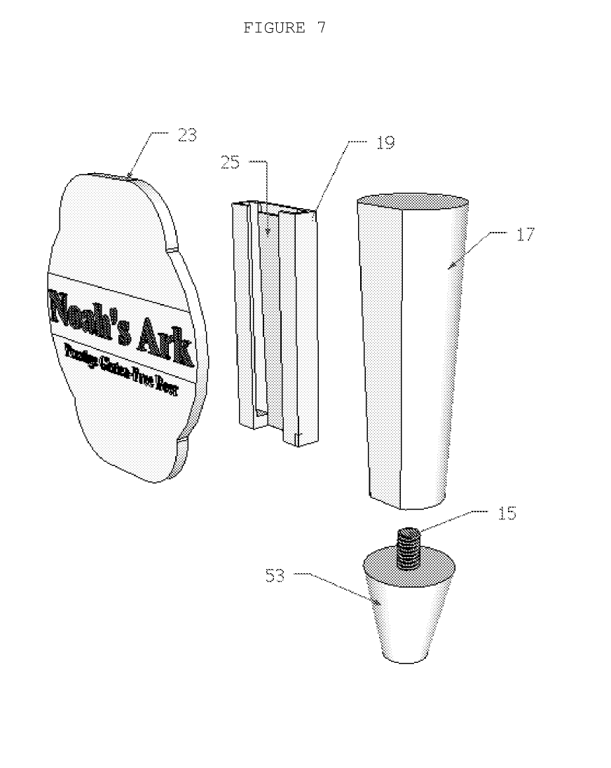

FIGS. 6 and 7 show a second embodiment of the invention for use on wine bottles and similarly constructed containers for liquid, is a Cork-Mounted Interchangeable Faceplate Assembly 31, comprising a Font Body 17 that connects to a Stud-Equipped Cork 53, by screwing the Female Mounting Threads 16 at the bottom of the Font Body 17 to the Stud-Equipped Cork 53, and the same Female Slide affixed to the Font Body 17 and a matching Male Slide 21 affixed to the back of the Faceplate 23. It should be noted that the cork in this embodiment need not be constructed of actual cork, but can also be constructed of rubber or other appropriate material.

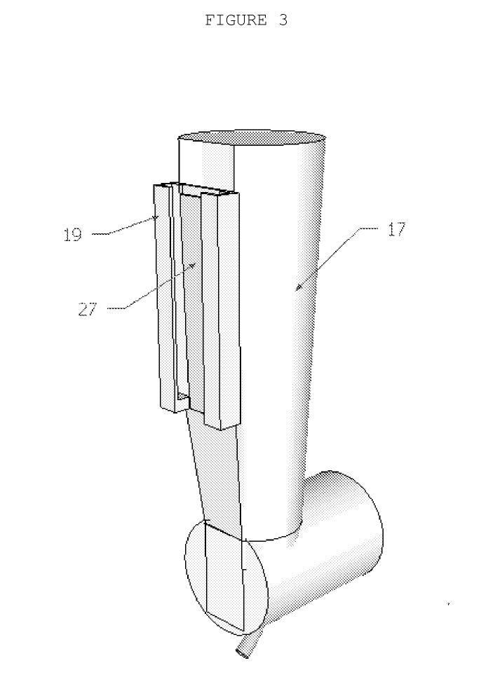

FIG. 3 depicts an orthogonal view of a first embodiment of a font mount without a faceplate installed. The Faceplate Female Slide 19 is visible, showing a stop at its bottom so a Faceplate 23 slides down from the top into the Slide 19 and is stopped at a proper position. An optional Font Body Magnet 27 is also visible. The optional Font Body Magnet 27 and Faceplate Magnet 25 pull the Faceplate 23 to the Font Body 17, making it less likely to slide off, and surprises would-be thieves who seek to steal a faceplate when the bartender's back is turned.

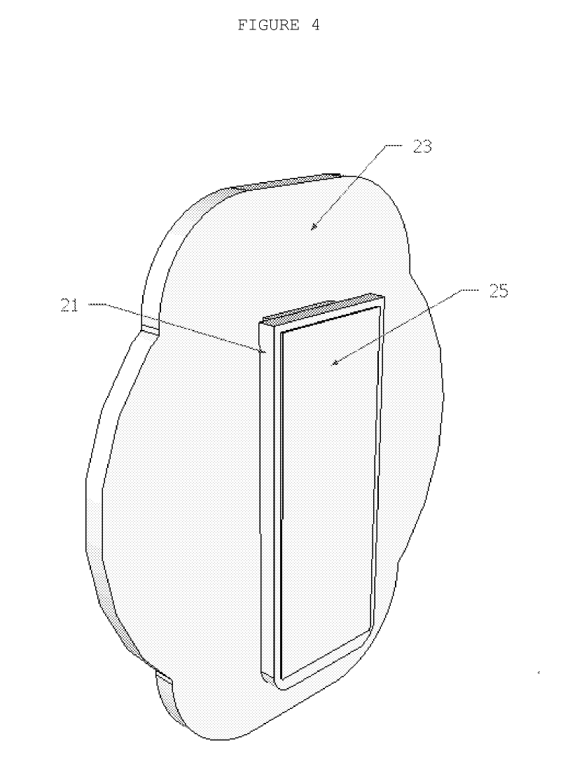

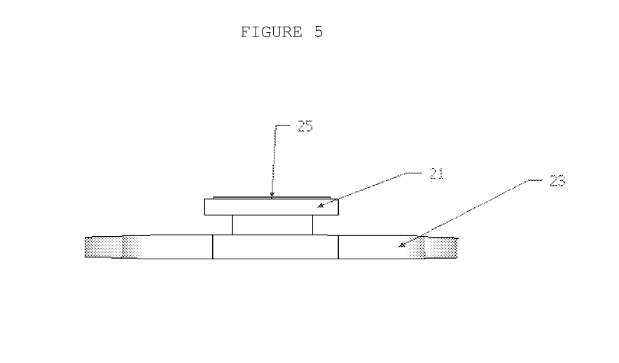

FIGS. 4 and 5 show the Faceplate 23 and its Male Slide 21. The Slide 21 has rounded corners on its lowest edge, for ease of entry into the Font Body Female Slide 19, but this shows an orthogonal view of the back of one embodiment of a faceplate.

FIG. 6 shows the Cork-Mounted Interchangeable Faceplate Assembly 31, with Faceplate 23 on a Font Body 17, affixed to the Stud-Equipped Cork 53. (The stud is visible in the exploded views.)

FIG. 7 is an orthogonal exploded view of a second embodiment of the invention, the Cork-Mounted Interchangeable Faceplate Assembly 31. This exploded view shows that the Stud-Equipped Cork 53 has the same mounting as the first embodiment of the invention, which is the industry standard for beer taps.

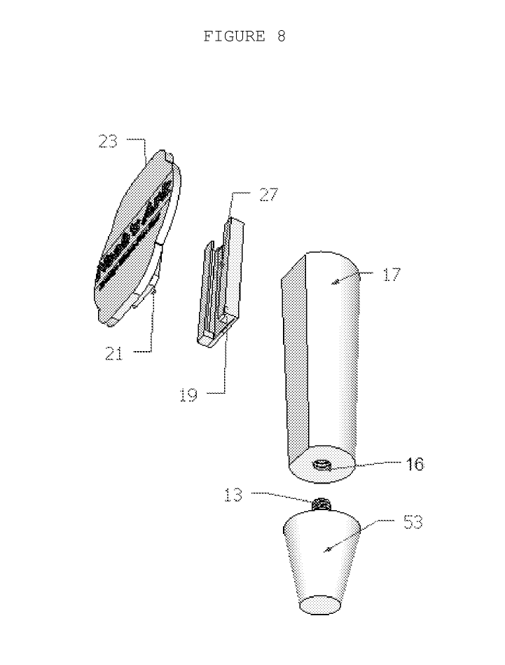

FIG. 8 is the same second embodiment of the invention as in FIG. 7, but from a lower angle, showing the Female Threads 16 of the Font Body 17, which are used for mounting of the invention.

As seen in FIGS. 4 and 5, an optional Faceplate Magnet 25 is mounted to the back of the Faceplate 23 in either configuration, allowing faceplates to be stored on a metal surface, such as a restaurant refrigerator's exterior wall. As already mentioned, the magnetic pull between the optional Faceplate Magnet 25 and optional Font Body Magnet 27 provides additional security, rigidity, and ease of installation.

Though the embodiments shown in this application include a slide mechanism, this disclosure and the invention are not limited to the described top-entry slide. Many other ways of attaching the Faceplate 23 to the Font Body 17 are possible, including snaps, a velco strap circling the Font Body 17, or a slide from a side position, or even a circular locking mechanism in which the Faceplate 23 is pushed onto a set of circular grooves at a 90° to vertical and rotated to a vertical position. The slide mechanism as described is a parallel edges so the slide has a consistent width, but the attachment means could include a V-shaped slide as well. One in the art could use any number of ways to affix the Faceplate 23 to the Font Body 17.

Thus, the embodiments and examples set forth herein are presented to best explain the present disclosure and its practical application and to thereby enable those skilled in the art to make and utilize the disclosure. As previously explained, those skilled in the art will recognize that the foregoing description and examples have been presented for the purpose of illustration and example only. The description as set forth is not intended to be exhaustive or to limit the disclosure to the precise form disclosed. Many modifications and variations are possible in light of the above teaching without departing from the spirit and scope of the following claims.

1. A Tap-Mounted Interchangeable Faceplate Assembly, comprising: a font body with a top, bottom and side, a set of female threads constructed in its bottom side, the female threads constructed to match a beer tap mounting stud found commonly on beer taps, and a means for connecting a faceplate to the side of the font body.

2. A Tap-Mounted Interchangeable Faceplate Assembly as in claim 1, in which means for connecting a faceplate to the side of the font body is a sliding clip in which the faceplate has a male element on its back side that mounts to assembly by sliding into a set of corresponding female grooves on the font body.

3. A Tap-Mounted Interchangeable Faceplate Assembly as in claim 1, in which an optional magnet is mounted on the back of the faceplate.

4. A Tap-Mounted Interchangeable Faceplate Assembly as in claim 1, in which a magnet is affixed to the back of the faceplate and another magnet is affixed to the font body, the two magnets mounted so they pull the faceplate and font body together during assembly.

5. A Cork-Mounted Interchangeable Faceplate Assembly, comprising: a font body with a top, bottom and side, a set of female threads constructed in its bottom side, the female threads constructed to match the threads of a stud that is embedded in the top of a wine bottle cork, and a means for connecting a faceplate to the side of the font body.

6. A Cork-Mounted Interchangeable Faceplate Assembly as in claim 5, in which an optional magnet is mounted on the back of the faceplate.

7. A Cork-Mounted Interchangeable Faceplate Assembly as in claim 5, in which a magnet is affixed to the back of the faceplate and another magnet is affixed to the font body, the two magnets mounted so they pull the faceplate and font body together during assembly.

8. A Cork-Mounted Interchangeable Faceplate Assembly, as in claim 5, in which the means for connecting a faceplate to the side of the font body is a sliding clip in which the faceplate has a male element on its back side that mounts to assembly by sliding into a set of corresponding female grooves on the font body.
